(19) United States
(12) Patent Application Publication
(10) Pub. No.: US 2011/0102290 A1
(43) Pub. Date: May 5, 2011

(54) ADJUSTABLE MULTI-BAND ANTENNA AND METHODS

(76) Inventor: Zlatoljub Milosavljevic, Kempele (FI)

(21) Appl. No.: 12/673,966

(22) PCT Filed: Aug. 20, 2008
(86) PCT No.: PCT/FI2008/050469

§ 371 Date: Jan. 7, 2011

(30) Foreign Application Priority Data
Aug. 30, 2007 (FI) 20075597

(51) Int. Cl. H01Q 1/50; H01Q 1/38

(52) U.S. Cl. 343/852; 343/700 MS; 343/876

(57) ABSTRACT

An adjustable multi-band planar antenna especially applicable in mobile terminals. The feed of the antenna can be connected by a multiple-way switch (SW) to at least two alternative points (FP1, FP2, FP3) in the radiator (310). When the feed point is changed, the resonance frequencies and thus the operating bands of the antenna change. Besides the basic dimensions of the antenna, the distance (x, y, z) of each feed point to other feed points and possible short-circuit point in the radiator, the value of the series capacitance (C31; C32; C33) belonging to a reactive circuit between the feed point and switch and the distance of the ground plane (GND) from the radiator are variables in the antenna design.

The invention relates to an adjustable multiband antenna especially intented to mobile terminals.

The adjustability of an antenna means in this description, that resonance frequencies of the antenna can be changed electrically. The aim is that the operating band of the antenna around a resonance frequency always covers the frequency range, which the function presumes at each time. There are different causes for the need for adjustability. The portable radio devices, like mobile terminals, have become smaller in all directions, also thickness-wise. In this case, regarding for example the planar antenna which is a very common antenna type in mobile terminals, the distance between the radiating plane and the ground plane unavoidably becomes shorter. This results in e.g. that the antenna's bandwidths will decrease. In addition, the reduction of the size of the devices means that also their ground plane becomes smaller. This leads to lowering of the capability of the planar antenna, because the antenna resonances become weaker and due to the ground plane's own resonances occurring at useless frequencies. Then, as a mobile terminal is intended for operating in a plurality of radio systems having frequency ranges relatively close to each other, it becomes more difficult or impossible to cover frequency ranges used by more than one radio system. Such a system pair is for instance GSM850 and GSM900 (Global System for Mobile telecommunications). Correspondingly, securing the function that conforms to specifications in both transmitting and receiving bands of a single system can become more difficult. In addition, if the system uses sub-band division it is advantageous from the point of view of the radio connection quality, if the resonance frequency of the antenna can be tuned in a sub-band being used at each time.

One possibility for reducing the antenna size is to implement it without the ground plane below the radiator. In this case the radiator can be of monopole type, then being resulted for example in an ILA (Inverted L-antenna) structure or the radiator can have also a ground contact, then being resulted in an IFA (Inverted F-antenna) structure.

In the invention described here the antenna adjustment is implemented by a switch. The use of switches for the purpose in question is well known as such. For example the publication EP1113 524 discloses an antenna, in which a planar radiator can at a certain point be connected to the ground by a switch. When the switch is closed, the electric length of the radiator is decreased, in which case the antenna resonance frequency becomes higher and the operating band corresponding to it is displaced upwards. A capacitor can be in series with the switch to set the band displacement as large as desired. In this solution the adjusting possibilities are very restricted.

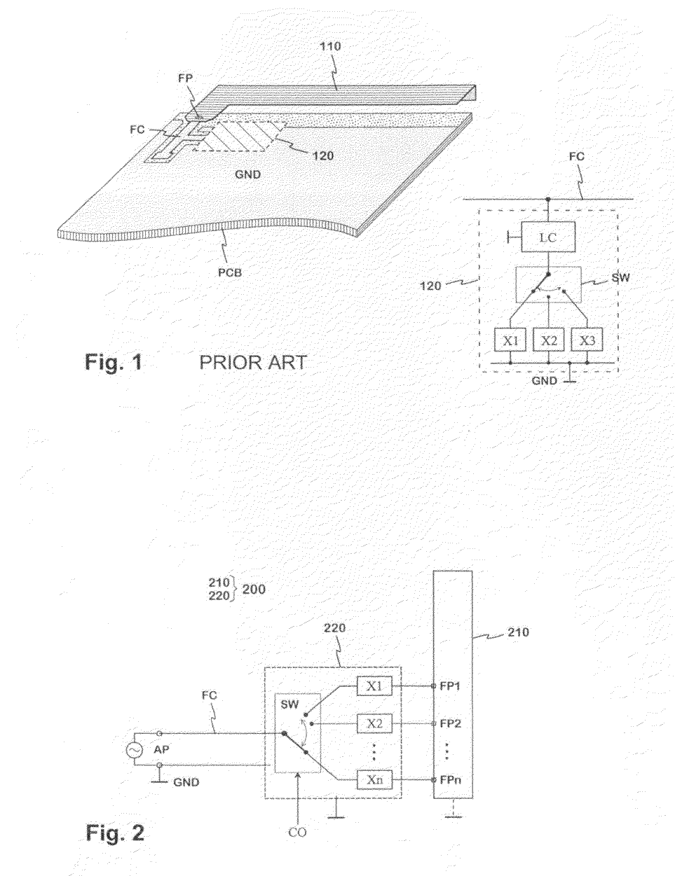

FIG. 1 shows an example of the ILA type with a switch, known from the publication WO 2007/042615. A portion of the circuit board PCB of a radio device is seen in the figure. The monopole radiator 110 is a plate-like and rigid sheet metal strip. It has been connected to the antenna feed conductor FC at the feed point FP being located near a corner of the circuit board. The radiator is directed from that point first over the edge of the end of the circuit board outside the board and turns after that onwards level with the upper surface of the circuit board in the direction of the end. On the circuit board there is the signal ground GND at a certain distance from the radiator 110. The radiator has a perpendicular fold part at the outer edge of the portion along the end of the circuit board to increase its electric length. On the circuit board, in the end on the radiator side, there is the adjusting circuit 120 of the antenna. The adjusting circuit is marked on the circuit board as an area confined by a broken line and shown as a block diagram in the side drawing. This drawing discloses that the adjusting circuit 120 has been connected between the antenna feed conductor FC and the signal ground GND. The adjusting circuit comprises an LC circuit, a multiple-way switch SW and three alternative reactive structure parts X1, X2, X3. The LC circuit has been connected to the feed conductor at its one end and to the switch input at its other end. Its aim is to attenuate the harmonic frequency components being generated in the switch and to function as an electrostatic discharge (ESD) protector of the switch. The switch SW has three outputs, to one of which the switch input can be connected at a time. Each output of the switch has been fixedly connected to one of said reactive structure parts, the reactances of which exist against the signal ground. The interchanging of the reactance by controlling the switch changes the resonance frequency of the antenna and thus the place of its operating band. The operating band of the antenna then has three alternative places in this example.

A drawback in the solution according to FIG. 1 and other like it is that good band characteristics and a sufficient efficiency demand a remarkable long distance between the radiator and ground plane. This again means that the space requirement for the antenna still is, also in this case, higher than the desirable one. In addition, it is difficult to arrange so that the antenna matching is good in both lower and upper operating band. A poor matching means also low efficiency.

The object of the invention is to implement the adjustment of an antenna in a new and advantageous way. An adjustable antenna according to the invention is characterized in that which is specified in the independent claim 1. Some advantageous embodiments of the invention are presented in the dependent claims.

The basic idea of the invention is as follows: An antenna is made adjustable in such a way that the antenna feed can be connected by a multiple-way switch to at least two alternative points in the radiator. When the feed point is changed, the resonance frequencies and thus the operating bands of the antenna change. Besides the basic dimensions of the antenna, the distance of each feed point to other feed points and possible short-circuit point in the radiator, the value of the series capacitance belonging to a reactive circuit between the feed point and switch and the distance of the ground plane from the radiator are variables in the antenna design. Also a tuning slot between the feed points can be used.

An advantage of the invention is that by choosing values to the above-mentioned variables suitably, the displacement of an operation band can be made relatively large, when the switch state is changed. In this way a relatively narrow band basic antenna functions in practice as a wide band antenna, because only a part of this wide band is needed at a time. Another advantage of the invention is that the displacements of two operating bands can be implemented independently from each other. A further advantage of the invention is that the efficiency of the antenna is better than the one of the corresponding known antennas. This is due to that when there are more than one feed point, by choice of their places the antenna matching can be improved in each operating band. This also results in that the space required for the antenna according to the invention is small, because the edge of the ground plane need not to be so far from the radiator than in the corresponding known antennas. Alternatively, the antenna component proper can be implemented in a smaller size. A further advantage of the invention is that the antenna structure is simple, which means relatively low production costs.

The invention is below described in detail. Reference will be made to the accompanying drawings where

FIG. 1 presents an example of an adjustable antenna according to the prior art,

FIG. 2 presents as a block diagram the principle of the antenna according to the invention,

FIG. 3 presents as a simple diagram an example of the adjustable antenna according to the invention,

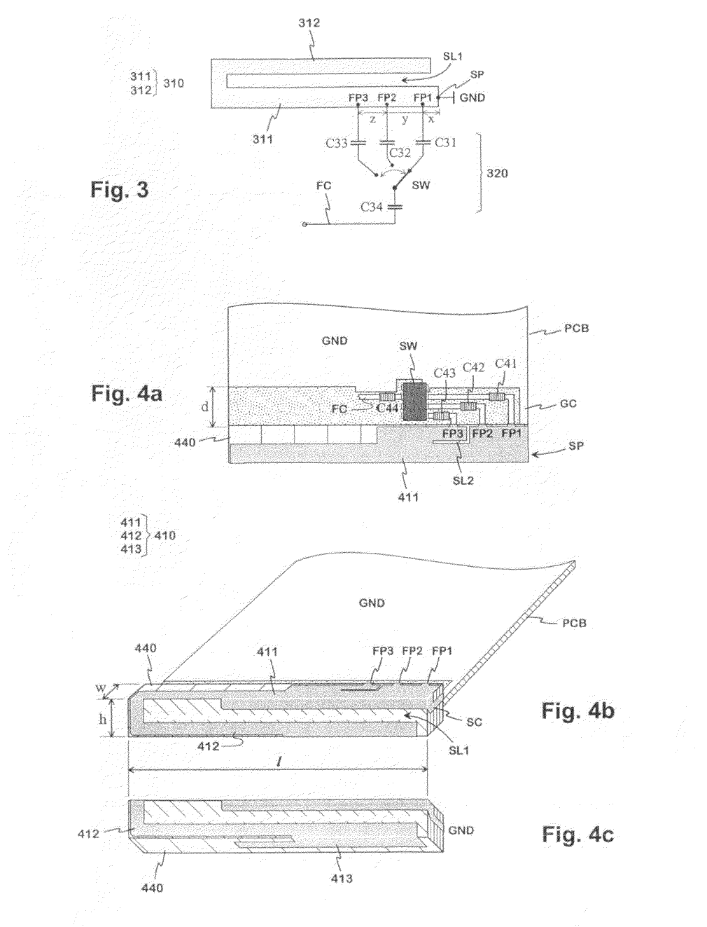

FIGS. 4a-c present an example of the implementation of the solution according to FIG. 3,

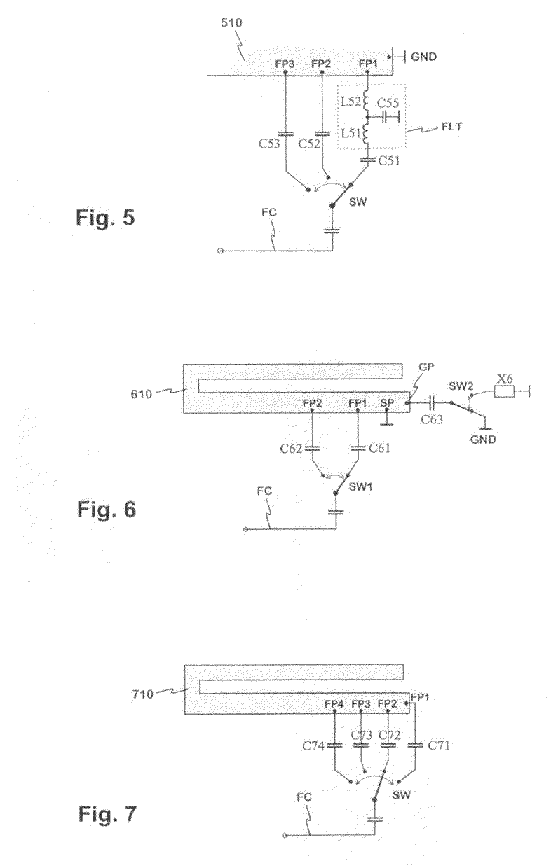

FIG. 5 presents a second example of the adjustable antenna according to the invention,

FIG. 6 presents a third example of the adjustable antenna according to the invention,

FIG. 7 presents a fourth example of the adjustable antenna according to the invention,

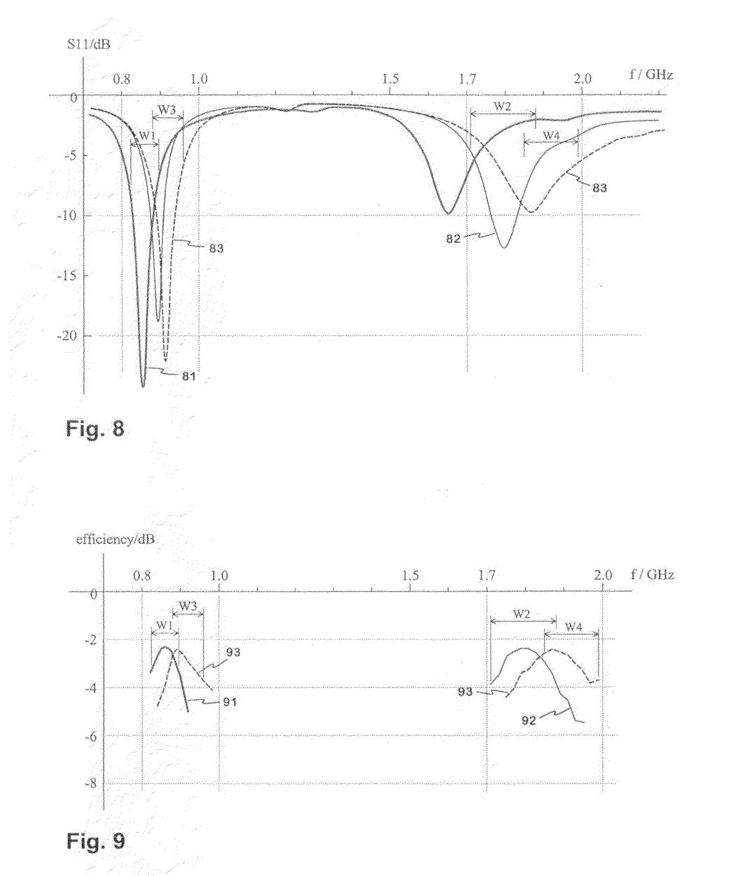

FIG. 8 presents an example of the width and displacement of operation bands of an antenna according to the invention, when the adjusting circuit is controlled, and

FIG. 9 presents an example of the efficiency of an antenna according to the invention.

FIG. 1 was already described in conjunction with the description of the prior art.

FIG. 2 shows as a block diagram the principle of the antenna according to the invention. The antenna 200 comprises a radiating element 210 and an adjusting circuit 220. Instead of normal one feed point, there are several feed points FP1, FP2, - - - , FPn in the radiating element. Symbol ‘n’ means that the number of the feed points can be chosen. The radiating element 210 is implemented so that the antenna has at least two separate operating bands, the lower one and the upper one. The adjusting circuit 220 comprises a multi-way switch SW and reactive circuits X1, X2, - - - , Xn. The number of the multi-way terminals, or outputs, of the switch SW is the same as the number of the feed points in the radiating element. Each feed point is connected to a different output of the switch through one reactive circuit. The common terminal, or input, of the switch SW is connected to the feed conductor FC of the antenna and further to the transmitter and receiver of a radio device through the feed conductor and antenna port of the radio device. The switch receives a control CO from the radio device.

By controlling the switch SW it can be selected, to which feed point the antenna feed conductor FC will be connected. When the feed point is changed, the resonance frequency/-cies of the antenna shift(s) a certain amount, which means that an operating band is displaced. In this way a relatively wide frequency range can be covered, although the operating band of the antenna would be relatively narrow at a time. An individual reactive circuit may be a capacitive tuning element designed so that the resonance frequency corresponding to the feed through it falls on a desired point. An individual reactive circuit may also be a filter, by which the frequency components above the operating band corresponding the feed point in question are attenuated, to prevent the antenna radiation at the harmonic frequencies of the frequencies of the operating band. Also the special case, where the reactance is zero, in other words a short-circuit, is here considered a reactive circuit.

The structure naturally also includes the common signal ground GND, or more briefly ground, necessary for the function of the structure. The radiator 210 can be connected to the ground from one or more points of it.

FIG. 3 shows as a simple diagram an example of the adjustable antenna according to the invention. The radiating element 310 is here connected to the ground GND from a short-circuit point SP at its one end, the antenna then being of IFA type. The radiating element comprises, starting from the short-circuit point, a first portion 311 and after it a second portion 312, which turns back towards the short-circuited end extending near it. A slot SL1 remains between the first and second portion, which slot is dimensioned so that it resonates at the frequencies of the antenna upper operating band. Thus the slot SL1 is a radiating slot, and the upper operating band is based on it. The lower operating band again is based on the resonance of the whole radiating element 310. Therefore, the whole radiator of the antenna comprises the radiating conductor element and the slot between its portions.

In the example the number of the alternative feed points in the radiating element 310 is three. Closest to the short-circuit point SP there is the first feed point FP1, a little distance from which along the first portion 311 there is the second feed point FP2 and further a little distance along the first portion 311 there is the third feed point FP3. An adjusting circuit 320 with a multiple-way switch SW and four capacitors is located between those feed points and the feed conductor FC coming from the antenna port. In this example the reactice circuits between the multiple-way switch SW and the radiator are mere serial capacitors: the first capacitor C31 is between the first output of the switch and the first feed point FP1, the second capacitor C32 is between the second output of the switch and the second feed point FP2 and the third capacitor C33 is between the third output of the switch and the third feed point FP3. The capacitors C31, C32 and C33 can be used for tuning purposes. They function in all cases also as blocking capacitors preventing the forming of a direct current circuit through the short-circuit conductor of the radiator to the ground, as seen from the control circuit of the switch. On the input side of the switch, in series with the feed conductor FC, there is further the fourth capacitor C34. This functions only as a blocking capacitor preventing the forming of a direct current circuit through the antenna feed conductor, as seen from the control circuit of the switch.

When the feed of the antenna takes place in the first feed point FP1, both the lower and upper resonance frequency and the operating bands corresponding to these frequencies are at the lowest. When the feed is changed to the second feed point FP2, both operating bands shift upwards, and when the feed is changed to the third feed point FP3, the operating bands further shift upwards. If a serial capacitor connecting to one of the feed points is used for tuning purposes, its capacitance is chosen to be so low that the electric length of the radiating element increases compared with the electric length which corresponds to the short-circuit of the capacitor in question. In that case also the place of the operating band in question changes, as well as the amount of its displacement in respect of the places of the operating bands, which correspond to the other feed points. Naturally also the distances between the feed points and their distance from the short-circuit point of the radiating element effect the amount of the displacements. In FIG. 3 the symbol x means the distance of the first feed point FP1 from the short-circuit point, y means the distance between the first and second feed point and z means the distance between the second and third feed point.

FIGS. 4a-c show an example of the implementation of the solution according to FIG. 3. The implementation utilizes the circuit board PCB of a radio device. In FIG. 4a the structure is seen from above in the direction of the normal of the circuit board and in FIG. 4b as a perspective presentation obliquely from above. In FIG. 4c the part, which comprises the antenna radiator, is seen as a perspective presentation obliquely from below. This part comprising the radiator consists of the radiating element 410 and its support frame 440. The support frame, or more briefly the frame, is an elongated object made of a low-loss dielectric material with a length l, width w and heigth h. The frame 440 is attached to the end of the circuit board PCB so that the longitudinal direction of the frame is the width direction, or the direction of the end of the circuit board, the width direction is the longitudinal direction of the circuit board and the heigth direction is perpendicular to the level of the circuit board. Correspondingly the frame has the upper and lower surface, the first and second end surface, and the inner side surface on the side of the circuit board PCB and the outer side surface. The support frame is hollow, for which reason the radiator is nearly air-insulated. This effects positively on the antenna efficiency.

The radiating element 410 is conductive coating of the frame 440. It has a first portion 411, a second portion 412 and a third portion 413. The first portion 411 covers most of the upper surface of the frame extending from the first end to the second end. The ‘end’ of the frame means a relatively short part of the frame on the side of the corresponding end surface. The first portion extends also a little to the outer side surface starting from the first end. The second portion 412 is a continuation to the first portion. It travels on the outer side surface from the upper surface near the lower surface in the second end and then to the first end in the longitudinal direction of the frame. The third portion 413 is a continuation to the second portion. It is located on the lower surface and its considerable part joins the second portion at the edge, which unites the lower surface and the outer side surface. The third portion further has a part being directed towards the second end of the frame, the end of which part is the electrically outermost end of the whole radiating element. The radiating element 410 is shaped so that it functions as a quarter-wave resonator in the lower operating band of the antenna. On the outer side surface of the frame, between the first 411 and second 412 portion of the radiating element there is a radiating slot SL1, which is, in accordance with the above-described matter, open in the first end of the frame and closed in the second end of the frame. The slot SL1 is dimensioned so that it functions as a quarter-wave resonator in the upper operating band of the antenna.

The radiating element 410 is connected from the short-circuit point SP in the first end of the frame to the ground plane GND on the circuit board by a short-circuit conductor SC, which is visible in FIGS. 4b and 4c. The short-circuit conductor goes around from the end surface of the frame to the inner side surface and connects then on the circuit board to the strip conductor GC, which belongs to the ground plane. The feed points of the radiator are located on the upper surface of the frame, on the side of the inner side surface. The first feed point FP1 is closest to the first end surface, relatively close to the short-circuit point SP. The second FP2 and third FP3 feed point are correspondingly located farther from the first end surface, however, also the latter is clearly closer to it than the second end surface.

The adjusting circuit, which is in accordance with the adjusting circuit 320 in FIG. 3, is located on the circuit board PCB next to the antenna component constituted by the frame 440 and the radiating element. Each feed point is connected to one of the serial capacitors C41, C42, C43 by a strip conductor, which falls on the inner side surface of the frame to the circuit board, and is soldered to a strip conductor on the surface of the circuit board. The other terminal of each capacitor C41, C42, C43 is connected to one output of the switch SW, and the input of the switch again to the antenna feed conductor FC through the fourth capacitor 044. The switch SW is an integrated component, in which the connecting parts proper are e.g. of FET (Field Effect Transistor), PHEMT (Pseudomorphic High Electron Mobility Transistor) or MEMS (Micro Electro Mechanical System) type. In the example the switch gets its control through a via from the other side of the circuit board.

There is also a small tuning slot SL2 in the radiating element 410 in the example of FIGS. 4a-c, which slot starts between the second FP2 and third FP3 feed point. The tuning slot increases the electric distance of the third feed point from the other feed points and increases for this reason the displacement of at least the lower operating band, when the feed is changed to the third feed point.

In the example the edge of the ground plane on the circuit board PCB is at a certain distance d from the radiating element 410. Increasing the distance d from zero to a certain value increases the bandwidths of the antenna and improves the efficiency, but requires space on the circuit board, on the other hand.

FIG. 5 shows a second example of the adjustable antenna according to the invention. Its adjusting circuit is similar as in FIG. 3 with the difference that the first reactive circuit comprises now a filter FLT in addition to the first serial capacitor C51. The filter includes a coil L51 in series with the capacitor C51, a transverse capacitor C55 and a serial coil L52, the other terminal of which is connected to the first feed point FP1. The filter is then of low-pass type. Also the radiation impedance between the feed point FP1 and the ground, which is resistive in the resonance, belongs functionally to the filter. If only the lower operating band of the antenna is utilized when the feed point FP1 is in use, the boundary frequency of the filter FLT can be arranged between the lower and upper operating band. In this case the antenna does not radiate significantly at the harmonic frequencies of the basic resonance frequency, which corresponds to the lower operating band, because the filter attenuates the possible harmonics. If both the lower and upper operating band are utilized, when the feed point FP1 is in use, the boundary frequency of the filter FLT can be arranged above the upper operating band. In this case the radiation is prevented at the harmonic frequencies above the upper operating band.

A filter like the one shown in FIG. 5 can naturally also be in the reactive circuits, which connect to other feed points. In addition, a high-pass filter can be used, if there is reason to attenuate the signals falling onto the lower operating band.

FIG. 6 shows a third example of the adjustable antenna according to the invention. There are now two feed points FP1 and FP2 in the radiating element 610, which are coupled to the outputs of the multi-way switch SW1 through the serial capacitors C61, C62, as in FIG. 3. Also a short-circuit point SP is in the radiating element, as in FIG. 3. In addition a grounding point GP is in it in this example, which point is coupled to the input of a second multi-way switch SW2 through the blocking capacitor C63. The second multi-way switch SW2 has here two outputs, one of which is connected directly to the ground and the other to the ground through a reactance X6. When the state of the second multi-way switch is changed, the impedance between the grounding point GP and ground changes, in which case also the electric lengths and resonance frequencies of the antenna change. Because both the feed point and the impedance between the grounding point GP and ground can be changed, both operating bands of the antenna in FIG. 6 have in principle four alternative places.

The number of the outputs of the second multi-way switch SW2 and corresponding alternative impedances can also be more than two. On the other hand, the use of the switchable grounding point is naturally not tied to the number of the feed points.

FIG. 7 shows a fourth example of the adjustable antenna according to the invention. There are now four feed points FP1, FP2, FP3 and FP4 in the radiating element 710, which are coupled to the outputs of the multi-way switch SW through the serial capacitors C71, C72, C73, C74, as in FIG. 3. Differently, the radiating element is not short-circuited to the ground from any point, for which reason the antenna in the example is of ILA type (Inverted L-Antenna).

FIG. 8 shows an example of the width and displacement of operation bands of an antenna according to the invention, when the adjusting circuit is controlled. The example relates to an antenna, which is in accordance with FIGS. 4a, 4b. In it the length l of the radiator support frame is 40 mm, the heigth h is 5 mm and the width w is 5 mm. Also the distance d from the radiator to the edge of the ground plane is 5 mm. The second C42, third C43 and fourth C44 capacitor are mere blocking capacitors, the capacitance of which is 100 pF. The first capacitor C41 is a tuning capacitor, the capacitance of which is 3 pF. The antenna is designed for different GSM systems, the frequency ranges W1-W4 used by them are marked in the figure:
W1=the frequency range 824-894 MHz used by US-GSM
W2=the frequency range 1710-1880 MHz used by GSM1800
W3=the frequency range 880-960 MHz used by EGSM (Extended GSM)
W4=the frequency range 1850-1990 MHz used by GSM1900

Curve 81 shows fluctuation of the reflection coefficient S11 as a function of frequency, when the feed conductor FC is connected to the first feed point FP1, curve 82 shows fluctuation of the reflection coefficient, when the feed conductor is connected to the second feed point FP2 and curve 83 shows fluctuation of the reflection coefficient, when the feed conductor is connected to the third feed point FP3. The first feed point FP1 is used, when the radio device functions in the US-GSM system. (In this case the upper operating band in the frequency 1.6-1.75 GHz remains unused.) It can be found from curve 81 that the above-mentioned frequency range W1 will be covered so that the reflection coefficient is −7 dB or better. The second feed point FP2 is used, when the radio device functions in the GSM1800 system. (In this case the lower operating band around the frequency 900 MHz remains unused.) It can be found from curve 82 that the above-mentioned frequency range W2 will be covered so that the reflection coefficient is −4.5 dB or better. The third feed point FP3 is used, when the radio device functions in the EGSM or GSM1900 system. It can be found from curve 83 that the above-mentioned frequency range W3 will be covered so that the reflection coefficient is −6 dB or better and the frequency range W4 so that the reflection coefficient is −5.5 dB or better.

When the first feed point FP1 is changed to the third feed point FP3, or vice versa, the lower operating band of the antenna shifts about 60 MHz. Such a displacement is implemented by the low capacitance of the first capacitor C41 and the tuning slot SL2, seen in FIG. 4a.

FIG. 9 shows an example of the efficiency of an antenna according to the invention. The efficiency has been measured in the same antenna as the reflection coefficient curves in FIG. 8, the antenna being in free space. Curve 91 shows the fluctuation of the efficiency as a function of frequency in the lower operating band, when the feed conductor FC is connected to the first feed point FP1, curve 92 shows fluctuation of the efficiency in the upper operating band, when the feed conductor is connected to the second feed point FP2 and curve 93 shows fluctuation of the efficiency in both operating bands, when the feed conductor is connected to the third feed point FP3. It can be seen from the curves that the efficiency in the above-mentioned frequency ranges W1, W2, W3 and W4 is about −3 dB on average.

The adjustable antenna according to the invention has been described above. Its structure can naturally differ in detail from that which is presented. The radiating element of the antenna can also be a quite rigid metal sheet, the feed points of which are connected by spring contacts. The spring can in this case be constituted of a bent projection of the radiator or it can be a threaded spring inside a so-called pogo pin. The radiating element can be located also e.g. on the surface of a ceramic substrate. The ground plane can also extend below the radiator. The capacitive elements of the reactive circuits can be implemented, instead discrete capacitors, also by short open or short-circuited planar transmission lines. The antenna can be a PIFA (Planar IFA) provided with several feed points. It can comprise also a parasitic element, by means of which one extra resonance and operating band are implemented. The inventive idea can be applied in different ways within the scope set by the independent claim 1.

1.-10. (canceled)

11. A multiband antenna having at least a lower operating frequency band and an upper operating frequency band, the antenna comprising:
a dielectric element having a first dimension;
a conductive coating deposited on the dielectric element, the conductive coating having a first portion and a second portion, wherein said first and second portions are formed substantially parallel to each other along said first dimension;
a feed structure, comprising at least a first and a second feed points, said feed structure coupled to the conductive coating; and
a nonconductive slot formed between the first and second portions along said first dimension;
wherein said slot is configured to form a quarter wave resonator in said upper operating band; and
wherein said first and second portions cooperate to form a quarter wave resonator in said lower operating band.

12. The antenna of claim 11, wherein said first dimension comprises a substantially transverse dimension.

13. An antenna according to claim 11, wherein said radiating element further comprises a tuning slot disposed between said first and said second feed points.

14. An antenna according to claim 11, further comprising:
a signal ground;
at least first and second impedance circuits; and
a multi-way switch, comprising:
at least one input port; and
at least a first and a second output ports;
wherein said input port of said multi-way switch is coupled to said radiating element; and
wherein said at least first and second output ports of said multi-way switch are coupled to said signal ground via said least a first and a second impedance circuits, respectively.

15. An antenna according to claim 14, wherein said radiating element is short-circuited to said signal ground, thereby forming a in inverted-F antenna structure.

16. The antenna of claim 14, wherein said at least first and second impedance circuits comprise substantially different impedance.

17. An antenna according to claim 14, wherein said radiating element further comprises a tuning slot disposed between said first and said second feed points.

18. The antenna of claim 11, further comprising at least first and second reactive circuits;
wherein said first feed point is electrically coupled to a transceiver via said first reactive circuit; and
wherein said second feed point is electrically coupled to a transceiver via said second reactive circuit.

19. An antenna according to claim 18, wherein at least one of said at least first and second reactive circuits comprises a serial capacitor arranged to increase the electric length of said radiating element.

20. An antenna according to claim 18, wherein at least one of said at least first and second reactive circuits comprises a low-pass filter configured to substantially mitigate radiation at the harmonic frequencies of a resonance frequency corresponding to at least one operating band.

21. An antenna according to claim 18, wherein at least one of said at least first and second reactive circuits comprises a planar transmission line.

22. An antenna operable in at least a lower and an upper operating frequency bands, said antenna comprising:
a radiating element having at least first and second feed points, a ground point, and a short circuit point;
a selector circuit configured to select at least one of said at least lower and upper operating frequency bands, said selector circuit comprising:
a first multi-way switch, having at least one input port and at least first and second output ports; and
at least first and second reactive circuits;
wherein, said first and second feed points are coupled to said first and second output ports through said first and second reactive circuits, respectively.

23. A mobile radio device comprising an antenna operable in at least a lower and an upper operating frequency bands, a feed structure, and a signal ground, said antenna comprising:
a radiating element having at least first and second feed points, a ground point, and a short circuit point;
a selector circuit configured to select at least one of said at least lower and upper operating frequency bands, said selector circuit comprising:
a first multi-way switching element, having at least one input port and at least first and second output ports; and
at least first and second reactive circuits;
wherein, said first and second feed points are coupled to said first and second output ports through said first and second reactive circuits, respectively; and
wherein said at least one input port is configured to be coupled to said antenna through said feed structure.

24. An antenna according to claim 23, wherein said radiating element is electrically coupled to the mobile radio device only via said at least a first and a second feed points, thereby forming an inverted-L antenna structure.

25. A method of operating multi-band antenna, the antenna comprising a radiating element, and at least first and second feed points, the method comprising:
selectively electrically coupling said first feed point to a transceiver via a first of a plurality of reactive circuits; or
selectively electrically coupling said second feed point to a transceiver via a second of a plurality of reactive circuits;
wherein the first and second reactive circuits cause the antenna to operate in first and second frequency bands, respectively.

26. The method of claim 25, wherein the radiator element further comprises a first portion, a second portion, and a tuning circuit, and the method further comprises utilizing said tuning circuit to selectively alter at least one of the first and second frequency bands.

27. An adjustable antenna of a radio device, said radio device comprising an antenna port, said antenna comprising:
a signal ground;
a radiating element, comprising:
at least a first and a second feed points;
a ground point; and
a short circuit port;
a feed conductor; and
an adjusting circuit configured to effect at least one of said at least lower and upper operating frequency bands, said circuit comprising:
a first multi-way switch, comprising at least one input port and at least a first and a second output ports; and
at least first and second reactive circuits;
wherein, said first and second feed points are coupled to said first and second output ports through said first and second reactive circuits respectively; and
wherein said at least one input port is configured to be coupled to said antenna through said feed conductor.

28. An antenna according to claim 27, wherein said radiating element further comprises:
a first portion; and
a second portion, formed substantially parallel with said first portion; and
a nonconductive slot formed substantially between the first portion and the second portion;
wherein said nonconductive slot is sized so as to form a resonance in said upper operating frequency band; and
wherein said radiating element is configured to form a resonance in said lower operating frequency band.

29. An antenna according to claim 27, wherein at least one of said at least first and second reactive circuits comprises a serial capacitor arranged to increase the electric length of said radiating element.

30. An antenna according to claim 27, wherein at least one of said at least first and second reactive circuits comprises a low-pass filter configured to substantially mitigate radiation at the harmonic frequencies of a resonance frequency corresponding to at least one operating band.

31. An antenna according to claim 27, wherein at least one of said at least first and second reactive circuits comprises a planar transmission line.

32. An antenna according to claim 27, wherein said radiating element is electrically coupled to the radio device only via said at least a first and a second feed points, thereby forming an inverted-L antenna structure.

33. An antenna according to claim 27, wherein said multi-way switch is selected from the group consisting of:
a field-effect transistor (FET) switch;
a pseudomorphic high electron mobility transistor (PHEMT) switch; and
microelectromechanical system (MEMS) switch.

34. An antenna according to claim 27, wherein said radiating element is short-circuited to said signal ground from said short-circuit port, thereby forming a in inverted-F antenna structure.

35. An antenna according to claim 34, further comprising:
at least a first and a second impedance circuits; and
a second multi-way switch, comprising:
at least one input port; and
at least a first and a second output ports;
and wherein:
said input port of said second multi-way switch is coupled to said radiating element ground point;
said at least first and second impedance circuits comprise substantially different impedance; and
said at least first and second output ports of said second multi-way switch are coupled to said signal ground via said least a first and a second impedance circuits.

36. An antenna according to claim 34, wherein said radiating element further comprises:
a tuning slot disposed between two adjacent feed points, and configured to increase the electric distance between the first and the second of said two adjacent feed points, thereby increasing the displacement of at least one of said at least a lower and an upper operating frequency bands.
